(19) United States
(12) Patent Application Publication
(10) Pub. No.: US 2022/0315471 A1
(43) Pub. Date: Oct. 6, 2022

(54) TEMPERING FURNACE FOR A GLASS SHEET AND A METHOD FOR HEATING A GLASS SHEET FOR TEMPERING

(71) Applicant: Glaston Finland Oy, Tampere (FI)

(72) Inventors: Jukka VEHMAS, Tampere (FI); Kyösti KETO, Tampere (FI)

(73) Assignee: Glaston Finland Oy, Tampere (FI)

(21) Appl. No.: 17/597,303

(22) PCT Filed: Jun. 25, 2020
(86) PCT No.: PCT/FI2020/050459

§ 371 Date: Dec. 31, 2021

(30) Foreign Application Priority Data
Jul. 3, 2019 (FI) 20195604

(51) Int. Cl. C03B 29/08; C03B 27/04; C03B 27/012

(52) U.S. Cl. CPC C03B 29/08; C03B 27/0404; C03B 27/012

(57) ABSTRACT

A tempering furnace for a glass sheet has a conveyor for the glass sheet, and first convection blow means over the conveyor to heat the glass sheet by hot air jets blown onto its top surface. With second convection blow means, pressurized air external to the tempering furnace may be led to second blow nozzles from which air is discharged as jets towards the bottom surface of the glass sheet. The heating effect of the air jets of the first convection blow means onto the glass sheet is adjustable by adjusting the feeding of electric current to electric elements inside blow enclosures, and the heating effect onto the glass sheet of the jets discharging from the second blow nozzles is adjustable by adjusting the blow pressure of feed pipes.

The present invention relates to a furnace for heating glass sheets to temper them.

It is an object of the present invention to substantially improve the quality of tempered glass sheets and the capability of tempering furnaces in the even heating of ever more difficult glass sheets.

### BACKGROUND OF THE INVENTION

Tempering or heating furnaces for glass sheets, in which glass sheets move in one direction or back and forth on rotating ceramic rollers, and from which they, at a tempering temperature, move successively, side by side, or as mixed glass loadings along a roller track to a tempering cooling unit at the back of the furnace, are commonly known and used. In a tempering furnace, glass sheets are heated from a factory temperature to the tempering temperature of 610 to 680° C., depending on the thickness of the glass. The temperature in a furnace is typically 700° C. The heating of a glass sheet typically takes 40 s per one mm of glass thickness, that is, 160 seconds for the glass thickness of 4 mm, for example. The thickness of glass sheets to be tempered is usually 1 to 25 mm.

In a tempering furnace, heat is transferred to the glass by radiating from the inner surfaces of the furnace, by convection from air, and by direct conduction from the contact points between the conveyor and the glass sheet. In convection, or to be more precise, forced convection, air streams are directed to the surfaces of the glass sheet by means of flow machines.

Circulated air convection refers to an air blow towards a glass sheet, brought about by circulating air in the furnace by means of blowers. In pressurised air convection, the blowing of air towards the glass is carried out by leading pressurised air into the furnace from outside the furnace. In circulated air convection, the blowing pressure is typically from 100 to 2000 Pa, and in pressurised air convection from 0.1 to 5 bar. The diameters and quantities of blow openings in pressurised air convection are notably smaller than in circulated air convection. The problems with pressurised air convection in relation to circulated air convection are energy losses and inefficiency at the final stage of heating, in particular, because the air in the furnace cools down. Due to insufficient convection capability, even heating of the top and bottom surfaces of the newest glass sheets, coated to reflect more and more thermal radiation, is unsuccessful with pressurised air convection or requires an excessively long heating time. The advantages of pressurised air convection in relation to circulated air convection include very quick adjustability and a lower price of the equipment.

In terms of quality of tempered glass sheets, it is important that the glass sheets warm up evenly in the furnace. When being heated, the surfaces of the glass sheets warm up faster than the centre thickness, thereby forming a temperature profile in the thickness direction in the glass sheet. The temperature profile should be symmetric enough, in other words, the top and bottom surface should warm up at approximately the same rate. A difference in the heating rate of the top and bottom surface results in momentary bending of the glass sheet during heating due to the difference in the thermal expansion of the surface layers. The bending in question causes quality problems, such as white haze. Uncoated or so-called clear glass rather efficiently absorbs thermal radiation from a furnace. What is particularly challenging is to heat glass which has one surface, usually the top surface, coated with coatings that particularly efficiently reflect thermal radiation. Such selective and low emissivity coatings are in common use in windows, for example, to lower the energy consumption of buildings. When taking into consideration the practical quality and capacity requirements, the heating of a low emissivity, coated glass sheet is impossible without convection by means of which the radiation heating difference between a clear and coated glass sheet is compensated. In the aforementioned tempering furnace, the problem of heating glass which strongly reflects radiation on its top surface (=problem 1), the problem becoming more pronounced as the reflectivity of the coating and glass thickness increase, is thus solved by directing relatively powerful convection on the top surface of the glass by means of the inventive circulated air convection apparatus having adequate convection capability and by which convection and radiation heating may be well managed and targeted to a limited degree. The remaining problem in focusing, to be discussed next, is solved with the inventive pressurised air convection. The convection combination according the invention is also an excellent help in heating clear glass sheets.

The side and end edges of a glass sheet have a tendency of heating up slightly faster and more than the centre area of the glass sheet in a tempering furnace because the furnace surfaces radiating on them are subjected to a load and thus cool down less during a heating cycle. In addition, the heat stream conducted from the rollers through the contact points of the roller and the glass to the glass is, due to the aforementioned difference in loading, larger on the side edges, and in particular at the front ends, larger than at the centre area of the glass. At times, the surfaces of glass sheets to be tempered are only partly painted, or a low emissivity coating has been removed from the edge areas. Usually a surface differing in the aforementioned manner is the top surface of a glass sheet in a tempering furnace. For these reasons, among others, the uneven heating up of the surface area of the glass sheet leads to variation in the tempering temperature of the surface area of a glass sheet, causing quality problems in tempered glass such as anisotropy and an increase in the unevenness of a breakage pattern. To solve this problem (=problem 2), the edge areas of a glass sheet require different kind of heating compared to the remaining areas of the glass sheet. The prior art solutions for simultaneously solving problems 1 and 2 are not adequate.

In the tempering furnace of the reference publication EP2368855A2, air circulated in the furnace by a blower flows past an electric element in a nozzle enclosure and warms up before discharging as a jet from jet openings towards the glass. The heating effect of the air jets depends on the temperature of the jets, which depends on the electric current fed to the element. The electric element in the nozzle enclosure radiates heat to a nozzle deck which radiates heat to a glass sheet. This means that the radiation heating of the furnace is adjustable by the same electric element.

In the tempering furnace of the reference publication FI120734B, a glass sheet is heated by upper and lower convection blast and by upper and lower radiation heating. The tempering furnace has a plurality of nozzle pipes successively and in parallel. With the nozzle pipes, air pressurised outside the furnace by a compressor is blown as blasts on the surface of a glass sheet, and the blowing pressure of each nozzle pipe may be adjusted nozzle pipe specifically by valves outside the furnace. Adjusting is based on information on the shape of the load of glass sheets, which is obtained by the computer vision solution described in the reference publication. The convection blowing matrix described in the reference publication consists of 16 separate areas of adjustment whose blowing pressures may be adjusted by transverse and longitudinal adjustment valves.

### BRIEF DESCRIPTION OF THE INVENTION

To solve the prior art problems, the present invention relates to a tempering furnace for a glass sheet, which has a conveyor for the glass sheet, first convection blow means over the conveyor to heat the glass sheet by hot air jets blown on its top surface, whereby the first convection blow means include a blower pressurising air sucked from the tempering furnace, air channels to lead air from the blower to blow enclosures which have, on their bottom surfaces, first blow openings from which air is discharged as jets towards the top surface, electric elements inside the blowing channels heating air, and second convection blow means with the aid of which pressurised air from outside the tempering furnace may be led to second blow nozzles from which air is discharged as jets towards the bottom surface of the glass sheet, and the electric elements of the first convection blow means form a matrix-like separately-adjustable electric element field whereby the heating effect of the air jets on the glass sheet is arranged to be adjustable by adjusting the feeding of electric current to the electric elements, and the blow nozzles of the second convection blow means of the tempering furnace form blow zones, separately-adjustable in a matrix-like manner, the heating effect on the glass sheet of the jets discharged from the second blow nozzles inside the blow zones being arranged to be adjustable by adjusting the blowing pressure of feed pipes.

The invention additionally relates to a method for heating a glass sheet for tempering, in which method the glass sheet runs on a roller track in a tempering furnace, whereby the glass sheet is heated from the top and bottom sides and the top surface of the glass sheet is heated by hot air jets from the first convection blow devices, which are formed by sucking air from inside the tempering furnaces and pressurizing said hot air, heating it with electric elements inside blow enclosures, blowing the air as jets towards the top surface of the glass sheet, and blowing pressurised air taken from outside the tempering furnace by second convection blow means, wherein the heating effect on the glass sheet top surface of the air jets discharging from the blow enclosures of the first convection blow means towards the glass sheet is adjusted by adjusting the feeding of electric current to the electric elements, and the heating effect of the air jets discharged from the blow nozzles (11) of the second convention blow devices of the tempering furnace on the bottom surface of the glass sheet is adjusted by adjusting the feeding of air stream to the blow nozzles, and the heating effect is adjusted weaker at the front and rear end, and/or side edges, of the glass sheet moving in the tempering furnace than at the centre area of the glass sheet.

The inventive tempering furnace exhibits, over the glass loading, powerful circulated air convection which is adjustable in a matrix-like manner to carry out even heating of glass sheets that strongly reflect radiation on their top surfaces, and below the glass loading, dense pressurised air convection adjustable in a matrix-like manner to improve focusing of heating. Such a combination simultaneously solves the problem of heating glass that strongly reflects radiation on its top surface (=problem 1) and the problem of overheating the edge areas (or other deviating areas) of the glass (=problem 2). Such convection capability of the furnace makes it possible to heat the glass sheets ever more evenly and controllably, which improves the quality of the finished tempered glass.

As pointed out in the above, circulated air convection is generally speaking more efficient than pressurised air convection. Enhancing pressurised air convection is restricted by the air in the furnace cooling down and increased energy consumption along with the consumption of pressurised air. Circulated air convection does not have such restrictions. The main benefit of the inventive circulated air convection is its efficiency in relation to pressurised air convection, allowing fast and even heating of glass that reflects radiation. In addition, the adequately dense separate matrix-like adjustability of the inventive circulated air convection helps the aforementioned primary heating to succeed when heat is automatically transferred adjustment area specifically according to the local load, that is, the heat transferred to the glass. This also prevents an area of the furnace without glass from heating above a set value, whereby the furnace receives the subsequent glass sheet or load of glass well-balanced. Circulated air convection according to the invention may also be used for lateral profiling of heating, which can be done by setting lower set values for the electric elements (thermoelements) over the side edges of a glass sheet than for the electric elements between them. The profiling can, however, be accomplished in the manner described in the above only when the glass sheets of the load of glass are approximately of the same size and placed in successive approximately straight rows, i.e. their side edges are approximately on the same line in the direction of movement of the glass. In addition, the profiling need in the subsequent load of glass may be different or in another place of the furnace, and the furnace has no time without an additional delay period to be balanced temperature-wise before it moves into the furnace. In such a case, the profiling of the previous load of glass also partly affects the new load of glass, but the area of influence is wrong.

By momentarily changing the set values of the electric element field that heats the blowing air of circulated air convection it is not possible to prevent the front and rear ends of a glass sheet from overheating in relation to the remaining length of the glass, because the adjustment of the electric current of the electric element only shows in the heating with a delay which, in relation to the movement rate of the glass in the furnace, is much too long to focus additional convective heating on the aforementioned remaining glass length.

The overall benefit of pressurised air convection is its very fast adjustability, which the invention fully utilizes. By means of the pressurised air convection according to the invention, a different convection may be focused at different points of a bottom surface of a glass moving in a furnace, that is, convection may be focused on the centre area of the glass and leave the end and side edges without it. This way, overheating of the side edges of a glass sheet may be reduced, which is not possible by circulated air convection for the aforementioned reasons, or is at least very limited, such as with the inventive circulated air convection. According to vehicle standards, to prevent the formation of too large longitudinal glass fragments, which are prohibited in broken tempered safety glass, it is even advantageous to overheat the centre area of the glass in relation to glass edges, which may also be successfully accomplished with the inventive convection. Locally focused convection within the surface area of a glass sheet may also affect so as to prevent the glass sheet from bending when it is heated.

The aforementioned goal of the invention as a solver of prior art problems is achieved according to the present invention by combining circulated air convection overhead the glass sheet and adjustable in a matrix-like manner to carry out even heating of glass sheets with pressurised air convection underneath the glass sheet and adjustable in a matrix-like manner to improve the focusing of heating.

In the patent application, a convection blowing system adjustable in a matrix-like manner refers to such convection blow means that are divided into separately adjustable subareas both in the longitudinal and lateral direction of a tempering furnace. The subareas of the separately adjustable matrices are advantageously short and narrow, which improves the matrix-like adjustability and results in the advantages the invention aims at. The essential fact is that the heating up of the glass moving in the furnace may be managed both in the longitudinal and lateral directions of the glass, that is, convection may be focused in a matrix-like manner within the surface area of the glass. The smallness of the adjustment area is mostly limited by the rising costs in accordance with the quantity of the adjustment areas. Advantageously, focusing of some sort is achieved on a glass sheet 0.5 m wide and long, and convection focusing that is at least satisfactory is achieved on a glass sheet 1 m wide and long. The length of the glass sheets in the direction of movement of the glass heated up by the device in the furnace is usually 0.25 to 6 m and width 0.1 to 3.3 m. The width of the heating area of the furnace is usually 1.2 to 3.5 m, and the length 4 to 10 m. One load of glass may have as many as tens of glass sheets, depending on their size.

Preferred embodiments of the present invention are disclosed in the dependent claims.

In the following, the invention is described in closer detail with reference to the accompanying drawings, in which:

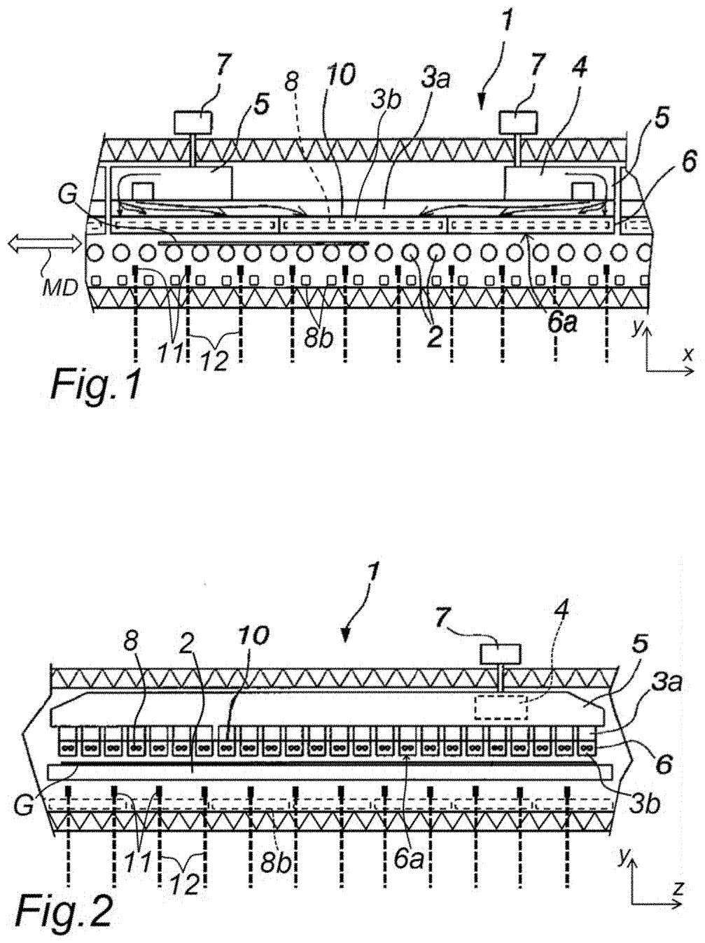

FIG. 1 is a side view (to direction z) of the inventive device according to a preferred embodiment

FIG. 2 is an end view (to direction x) of the device according to FIG. 1, and

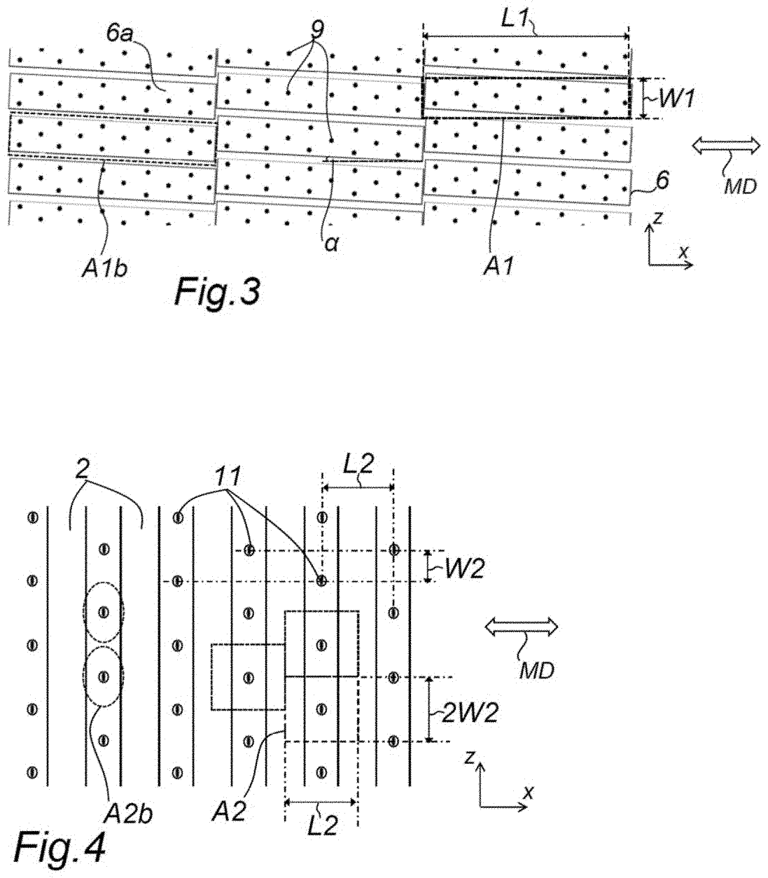

FIG. 3 shows blow enclosures overhead the glass sheet in accordance with the embodiment shown in FIG. 1, from below (as seen in direction y),

FIG. 4 shows is a top view of the blow nozzles underneath the glass sheet in accordance with the embodiment shown in FIG. 1 (as seen in direction y),

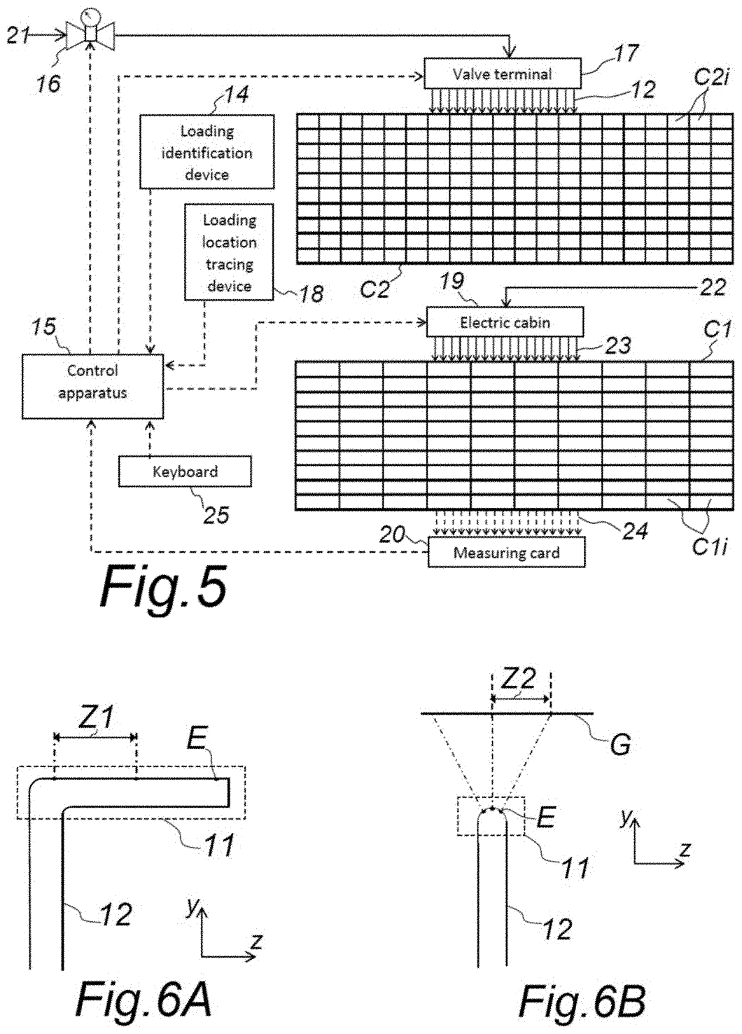

FIG. 5 is a schematic view of the device according to the invention

FIGS. 6A-B show alternative structures of a blow nozzle to even out the convection it has created in the lateral direction of the furnace.

### DETAILED DESCRIPTION OF THE INVENTION

FIGS. 1 and 2 show the inventive device to heat glass sheets for tempering. The device includes a tempering furnace which is denoted with the reference number 1. The tempering furnace 1 has a longitudinal and lateral direction, and a glass sheet moves in there from a loading table. Within the tempering furnace 1, a conveyor 2 has been arranged, which is a roller track, for example, on top of which glass sheets G may be carried in the longitudinal direction of the furnace. In the so-called continuous tempering furnace, a glass sheet moves through the furnace once, only, and in the so-called oscillating tempering furnace, a glass sheet moves back and forth until the heating time is up. In FIGS. 1, 3, and 4, the arrow MD indicates the movement direction of the glass inside an oscillating furnace. The rate of movement of the glass sheet in a tempering furnace is typically 50 to 200 mm/s. In an oscillating furnace, the rate at the moment at the time the direction changes is 0, from which the rate accelerates to the aforementioned value. From the tempering furnace, the glass sheet is transferred to a temperer in which it is intensely cooled down with air jets. The transferring rate is typically 200 to 600 mm/s.

Above the conveyor, advantageously at a short distance of typically 5 to 20 cm, advantageously 7 to 13 cm, there are arranged blow enclosures 6 on the side below which, on a so-called nozzle deck 6a, blow openings 9 have been formed to blow heated convection air towards the conveyor and, in particular, towards the glass sheet G being conveyed on the conveyor. The blow openings 9 are typically holes machined in a plate and having a diameter of 5 to 15 mm. To circulate the convection air blown on the glass sheet G, the tempering furnace 1 has means 3 to 8 arranged in it.

The blow enclosure 6 consists of a dividing part 3a in which air flown from division channels 5 in the lateral direction of the furnace, and blow part 3b which has electric elements 8 in it. In the blow enclosure, the dividing part 3a is connected to the blow part 3b by a perforated plate 10. The purpose of the perforated plate 10 is to even out blowing pressure differences between the various blow openings 9 of the blow enclosure. The blow openings 9 are on the nozzle deck 6a, on the surface of the blow enclosure 6, which faces the glass. The division channels 5 are equipped with recirculation blowers 4 which are inside the furnace 1. The drive motor 7 of the recirculation blower 4 is arranged on the outside of the furnace 1. It is provided with a frequency converter by means of which the rotating speed of the impeller of the blower may be varied and thus the blowing pressure of the blow openings covered by the blower adjusted. The furnace has one of more of the units shown in FIG. 1 successively.

Inside the blow enclosures 6, electric elements 8 have been arranged, with the air fed in the blow enclosure 6 heating up when it flows between them, and thus flows hotter into the blow openings 9 from which the air is discharged as jets towards the glass sheet G.

Each of the separately adjustable electric elements 8 has its own adjustment sensor which is advantageously attached to the bottom surface of the blow enclosure, in other words, the surface facing the glass. The sensor may also be placed slightly, advantageously approximately 1 to 30 mm, closer to glass sheet than the aforementioned bottom surface, or in a centralised manner in a blow opening i.e. air jet of a blow enclosure portion covered by one electric element. The adjustment sensor is advantageously a thermoelement. A dedicated set value temperature may be set for each thermoelement, and a dedicated so-called firing time for the electric element. The firing time determines the longest possible on time for the electric element, so the time period of feeding electric current, during one adjustment period. An advantageous duration for the adjustment period of the electric elements is 1 to 7 s. A firing time shorter than the adjustment period may thus be used to limit the power averaged in relation to the duration of the adjustment period of the electric element. Both the thermoelement set value and the firing time may be used to adjust different convection and radiation heating for adjacent and successive blow zones in the blow field. By adjusting the blowing pressure in the manner described in the above with a frequency converter, an adjustment matrix equally dense would require a dedicated blower and frequency converter for each nozzle enclosure, or some kind of blow enclosure specific flap valves that are difficult to implement and work imprecisely.

In addition, inside the tempering furnace, blow nozzles 11 have been arranged in a matrix-like manner to blow air through the gaps between the rollers 2 on the bottom surface of the glass sheet. Pressurised air is led into the blow nozzles through feed pipes 12.

In the drawings, the x direction is the direction of travel of the glass sheet, for which the z direction is the transverse horizontal direction. The y direction is the vertical direction

FIGS. 3 and 4 show an advantageous embodiment of the device according to the invention. FIG. 3 shows the blow enclosures 6 as seen from below. Here, each blow enclosure 6 is at the blow part 3b divided into successive enclosure parts of which 6a is a nozzle deck of one enclosure part, and of these each successive enclosure is installed at an acute angle α in relation to the travel direction x of the glass, whereby a staggered structure is formed even though the enclosure parts are in line in the travel direction of the glass in relation to each other. The aforementioned angle α is advantageously 2 to 10 degrees, more advantageously approximately 3 to 5 degrees. The enclosure parts may also be in straight rows without the staggering, whereby the direction of the rows and blow enclosure 6 is at the aforementioned angle in relation to the direction of travel x of the glass. In such a case, one nozzle deck 6a may be of the length of the entire blow enclosure 6, that is, one blow enclosure has one enclosure part, only.

In FIG. 4, in the gaps between the rollers 2, blow nozzles 11 are arranged in a matrix-like pattern. The blow nozzles 11 may be holes machined in the feed pipes 12, or separate nozzles fixed to the feed pipes. The flow cross sectional area of one blow nozzle is advantageously 0.5 to 4 mm². The blow nozzles 11 are approximately in the longitudinal lines of the furnace and lateral rows of the furnace, the rows being in the longitudinal direction of the furnace, so the x direction, at a distance L2 from each other. The distance L2 is typically 50 to 500 mm and advantageously 100 to 300 mm. Typically the distance L2 is 1 to 4 roller spacings (roller spacing=L2 in FIG. 4) and advantageously 1 to 2 roller spacings. In FIG. 4, the blow nozzles are so arranged that in the same line in the lateral direction of the furnace there is a blow nozzle 11 in every other gap between rollers, only, and the distance between blow nozzles is L2*2. In FIG. 4, the blow nozzle lines in the longitudinal direction of the furnace are in the lateral direction of the furnace, so the z direction, at a distance W2 from each other. The distance W2 is typically 20 to 250 mm and advantageously 30 to 140 mm. The distance between blow nozzles in the same gap between rollers, which in FIG. 4 equals 2W2, is advantageously 40 to 250 mm. The dimensions referred to in the above for the rows and lines of blow nozzles also apply to the positioning of the separately adjustable blow nozzles in the furnace.

In FIG. 3, the blow nozzles 6 are in the longitudinal direction of the furnace. In such a case, the width of the separately adjustable blow zone of circulated air convection in the lateral direction W1 of the furnace is advantageously, and in FIG. 3, the same as the blow enclosure distribution in the lateral direction of the furnace, so the width of the blow enclosure and gap in the lateral direction of the furnace. Typically, W1 is 30 to 300 mm and advantageously 60 to 160 mm. The length L1 of the separately adjustable blow zone of circulated air convection in the longitudinal direction of the furnace is typically 200 to 1500 mm and advantageously 300 to 1000 mm. Advantageously and in FIG. 3 the length L1 is the same as the length of the enclosure part in the longitudinal direction of the furnace.

FIGS. 3 and 4 show in closer detail the size of separately adjustable areas of the convection blow means of FIGS. 1 to 2. The surface area of one separately adjustable area of influence on a glass surface is A1b which in the z direction is slightly wider than the width of the nozzle deck 6a. This is the case because the blow jets affect a wider area on the glass surface than the surface area of the nozzle deck, depending on their blow distance to the glass. According to the preferred embodiment, the surface area of one separately adjustable area of influence of the second convection blow means on the surface A2b of the glass is oval shaped in FIG. 4. The pattern, as to its opening, corresponds to the blow nozzle 11 whose flow opening in the z direction is slightly wider than in the x direction. The figure does not show that the effect on the glass surface is biggest at the hitting centre point of the blow nozzle, and rapidly decreases when moving further away from it in the glass surface direction. In fact, it is impossible to determine unambiguously the exact size A2b of the area of influence of the blow nozzle 11 because it depends on the blow distance, that is, the distance in the y direction between the glass sheet and opening of the blow nozzle, and additionally on the definition of which kind of convection level is considered effective. Therefore, the size of cells C1i and C2i of the adjustment matrices C1 and C2, that is, the surface area of one separately adjustable area of influence of the convection blow means, is determined with cover areas A1 and A2. The cover area A1 is the surface area of the furnace heating area, or more specifically, the blow zone covered in the furnace A1tot by the first convection blow means, divided by the number N1 of separately adjustable electric elements in the blow enclosures within the area A1tot, and cover area A2 is the blow zone in the oven covered by the second convection blow means A2tot, divided by the number N2 of separately adjustable blow nozzles within the area A2tot. In FIG. 3, the surface area A1b is approximately equal to the surface area A1, because the gaps 13 between the blow enclosures are narrow. As the separately adjustable areas consist of one enclosure part of one nozzle enclosure, with its electric elements, and one blow nozzle 11, the cover area A1 with the FIG. 3 markings is W1*A1, and with the FIG. 4 markings the cover area A2 is 2W2*L2. Advantageously, the cover area A1 is 200 to 1500 cm2 and cover area A2 is 50 to 600 cm2. In addition to the pursued adjustment resolution, the number N1 and N2 of the furnace-specific cells of the adjustment matrix depend on the furnace size. They typically increase as the size of the furnace increases. In a furnace N1 is at least 40 pcs and N2 is at least 40 pcs. In one furnace N1 is advantageously at least 80 pcs and N2 at least 160 pcs.

According to a preferred embodiment, there are at least 6 pcs of separately adjustable blow zones of the first convection blow means in the lateral direction of the tempering furnace in the same lateral area, and at least 8 pcs of separately adjustable blow zones of the second convection blow means in the lateral direction of the tempering furnace at the same gap between rollers, and at two successive gaps between rollers at least 16 pcs.

According to a second preferred embodiment, there are at least 6 pcs of separately adjustable blow zones of the first convection blow means in the longitudinal direction of the tempering furnace in the same longitudinal area, and at least 12 pcs of separately adjustable blow zones of the second convection blow means in the longitudinal direction of the tempering furnace in essentially the same longitudinal line.

As described in the preferred embodiment of FIGS. 1 to 4, the second convection blow means comprise feed pipes 12 passing through the bottom of the furnace, which are adapted to run between the gaps of the bottom electric elements 8b and which end at the second blow nozzles 11.

FIG. 5 is a schematic view of the device according to the invention. The tempering furnace comprises a detector 14 which reads information concerning the loading of glass sheets, which may be, for example, a camera shooting the load of glass on a loading table, or a dense row of capacitive or optical sensors transversely to the direction of movement of the glass, over which the load of glass moves as it is being transferred to the tempering furnace. The detector 14 sends its information, that is, information needed for solving the shape dimensions of the load of glass, to a control device 15 which is a computer, for example. The tempering furnace further comprises a device 18 producing information needed to determine the location of the glass sheets within the glass furnace, which is, for example, a servo motor of the conveyor of the tempering furnace, or a pulse sensor connected to the actuators of the conveyor.

The second convection blow devices are controlled as in the following, for example. An operator uses a keyboard 25 to give a control device 15 the blowing pressure and glass sheet specific blow zone where the blowing from blow nozzles 11 is to be focused. As mentioned, the blow pressure of the separately-adjustable blow nozzles of the furnace changes in relation to at least the location of the glass sheets so that the blowing pressure is higher in the centre area of the glass sheets than in a glassless area of the furnace or in the edge area of the glass sheets. The control device 15 may itself also select this information on the basis of the glass sheet size, for example. The adjustment setting defines 3 bar, for example, as the blowing pressure, and the entire surface area of the glass sheet as the blow zone, excluding 20 cm from the front and rear ends, and 15 cm from both side edges. An adjustment valve 16 adjusts itself to the set value of the blowing pressure, that is, chokes the pressure of the pressurised air source 21 to the 3-bar feed pressure of a valve terminal 17. The pressurised air source, so the device feeding pressurised air in from outside the furnace, is advantageously a pressurised air compressor with an advantageous delivery overpressure of 6 to 12 bar. The blowing pressure into the furnace, that is, pressure difference over the blow nozzle, is advantageously 0.5 to 4 bar. The load of glass moves on to the furnace. The valve terminal 17 has a dedicated valve for each separately adjustable unit, so cell C2i, of the adjustment matrix C2 of the second convection blow devices. The valve is advantageously a shutter valve, that is, a valve having open and closed positions, only. The control device 15 controls the valves of the valve terminal by using information obtained from the detector 14 and device 18 so that the adjustment setting of the blow zone is realised as accurately as possible. The accuracy is limited by the width and length of the cells C2i, and by how the glass sheets are located in the furnace in relation to the cells. The accuracy may be improved by shortening the aforementioned dimensions of the cells. The profiling of the convection in the lateral direction of the glass is also improved by taking into account the location of the profiling lines in positioning the side edges of the glass when the glass sheets are being placed on the loading table. The control device may neglect the profiling and blow onto the entire glass, if an accurate enough calculated profiling cannot be obtained for the glass sheet. The blowing of pressurised air from blow nozzles at glassless areas is cut off. When the valve is open, pressurised air flows along the feed pipe 12 to the blow nozzle 11 from which it is discharged towards the glass sheet. Each cell C2i has its own feed pipe 12. When the valves of the valve terminal are of the type of the adjustment valve 16, a different blowing pressure may be set for different blow zones. The air discharge from a blow nozzle is linked to the blowing pressure. Both shutter and adjustment valves are thus used to adjust the mass flow of air discharged from the blow nozzles. The local heat flow q transferring from air to the glass sheet is the product of the convective heat transfer coefficient and the temperature difference between the air (Tair) and the glass sheet surface (Tglass), that is, q=h(Tair−Tglass). As the mass flow increases, the rate of the jet hitting the glass sheet increases, which adds to the heat transfer coefficient h. Thus, heat transfer to the glass sheet is increased, so the heating effect of the air jets on the glass sheet is enhanced. Therefore, the heating effect on the glass sheet of the air jets discharged from the blow nozzles of the second convection blow devices is arranged adjustable by a valve by adjusting the feeding of the air stream to the blow nozzles.

The first convection blow devices are controlled as in the following, for example. An operator chooses a blowing pressure for the blow nozzles 9. The blow pressure is typically set the same in each blower unit of the furnace, and it may be set to change in the middle of heating a glass sheet. The operator uses a keyboard 25 to enter the set temperatures and/or firing times for all the separately adjustable electric elements of the adjustment matrix C1, that is, cells C1i. The operator may, for example, drop the cells at the edges of the glass sheet to the set value 680° C. and keep the rest of the cells at the set value 700° C., and shorten the firing times of the electric elements at the beginning and end part of the furnace by 50%. The load of glass moves on to the furnace. Each cell C1i has its own switch in an electric cabinet 19, and a feed cable 23 for electric current. The switch is used to cut the electric current that an electric network 22 supplies to the electric element. The control device 15 controls the switches in the electric cabinet on the basis of the temperatures measured by the temperature sensors, set values of the temperatures, and firing times. There is a plurality of temperature sensor cables 24 connected to one measuring card 20. The heating effect of the air jets of the first convection blow devices on the glass sheet increases, because the electric element increases the temperature of the air jet, whereby the term (Tair−Tglass) in the aforementioned equation increases. Increasing the set temperature in cell C1i adds to the heat stream from the cell C1i to the glass sheet, so the consumption of electric current of the electric element of the cell also increases. Thus, both the set temperature and firing time affect the supply of electric current to the electric element. Therefore, the heating effect on the glass sheet of the air jets discharged from the blow nozzles of the first convection blow devices is arranged adjustable, adjustment area specifically, by adjusting the feeding of electric current to the electric element.

As noted in the above, the shape of the flow opening of the blow nozzles 11 is advantageously such that the jet discharged from them is wider in the lateral direction of the furnace than in the direction of movement of the glass inside the furnace. In such a case, the convection created by the jet on the surface of the glass evens out in the lateral direction of the glass. FIGS. 6A and 6B show further advantageous alternatives for evening out convection caused by a blow nozzle on a bottom surface of a glass sheet in the lateral direction of the furnace. In FIGS. 6A and 6B, one feed pipe 12 feeds air to a blow nozzle that has three separate flow openings. Advantageously, one blow nozzle (11) covers 3 separate flow openings (E), at most, which blow towards the glass sheet at different places of at least 10 mm and no more than 50 mm (5≤Z1≤60 mm) in the lateral direction of the furnace, or their focusing centre points on the bottom surface of the glass sheets are at different locations of at least 10 mm and at most 50 mm (5≤Z2≤60 mm) in the lateral direction of the furnace.

One feed pipe 12 may feed air to a plurality of blow nozzles when it is branched at the end to different blow nozzles. However, the blow openings of the separately adjustable blow zone of the second convection blow means advantageously consist of 2 blow nozzles, at most, so as to make the blow zones suitably sized The force of a single jet released from the blow nozzle of the second convection blow means must be sufficient so that its heating effect on the glass sheet is significant. To guarantee the above, the blowing distance to the glass has to be short enough. The blow nozzles are advantageously at the vertical distance of 150 mm, at most, from the surface of the glass. Advantageously, the blow nozzles are at a vertical distance of no more than the diameter of the roller 2+30 mm from the bottom surface of the glass.

According to an advantageous solution, the blowing pressure of the second convection blow devices changes in the middle of heating so that the blowing pressure of a jet hitting the centre area of a moving glass sheet is low, or even off, at the beginning of heating, because the aforementioned problem 1 is at its worst at the early stage of heating. At the same time, the set value for the blowing pressure of the first convection blowing devices is at its highest. Local focusing of the heating effect of the second convection blow devices within the surface area of the glass sheet is only commenced after at least 10% of the heating time has passed. The blowing pressure of the second convection blow devices onto the centre areas of the glass sheet is thereby at least doubled in order to be able to solve the aforementioned problem 2, too.

A solution according to an embodiment of the invention features, above a glass sheet, both circulated air convection adjustable in a matrix-like manner and pressurised-air convection adjustable in a matrix-like manner, so-called third convection blow devices, and below the glass sheet there is pressurised-air convection adjustable in a matrix-like manner. Such a combination improves focusing the heating within the surface area of the glass sheet when the inventive pressurised air convection also acts on the top surface of the glass. On the other hand, adding pressurised air convection pipes over the glass sheet and among circulated air convection is difficult and adds to the cost. The features described in the above for the second convection blow devices also suit the third convection blow devices, but instead of rollers, their positioning is restricted by the blow enclosures of the first convection blow devices. Advantageously, air from outside the furnace is fed to the blow nozzles of the third blowing devices with feed pipes running through the ceiling of the tempering furnace and adapted to run in the gaps between the blow enclosures so that the blow nozzles are in the gaps between the blow enclosures or closer to the glass sheet than the blow openings of the first convection blow means. Advantageously the blowing distance to the glass is no more than 150 mm.

The invention described in the above is not restricted to the disclosed embodiment, but it may be varied in a number of ways within the scope defined by the claims. For example, the blow enclosures may be longitudinal, transverse, or at any skew angle in relation to these directions. The gas circulated in or blown into the furnace may be other than air, too. It may also be a mixture of air and another gas. The channels feeding air to the blow enclosures may differ from the described and it may have a different number of blowers.

1. A tempering furnace for a glass sheet, comprising:
a conveyor configured to convey the glass sheet;
a detector configured to provide information for determining shape dimensions of a load of glass;
a device configured to produce information for determining a momentary location of the glass sheet inside the tempering furnace;
first convection blow means configured to heat the glass sheet by hot air jets, wherein the first convection blow means include a blower configured to pressurize air sucked from the tempering furnace, air channels configured to lead air from the blower to blow enclosures which have, in surfaces of the blow enclosures facing the glass sheet, blow openings from which air is discharged as jets towards a top surface of the glass sheet, and electric elements inside the blow enclosures configured to warm up air;
second convection blow means; and
control devices configured to control valves of the second convection blow means based on the shape dimensions of the load of glass and the location of the glass sheet, and to cause the valves to lead second convection blow means pressurized air external to the tempering furnace to blow nozzles of the second convection blow means from which air is discharged as jets towards a bottom surface of the glass sheet,
wherein the electric elements and blow enclosures of the first convection blow means form a first plurality of separately-adjustable blow zones in longitudinal and lateral directions of the tempering furnace, in which a heating effect of the air jets on the glass sheet is adjustable by adjusting a feeding of electric current to the electric elements, there being at least 40 pieces of the first plurality of separately-adjustable blow zones in the tempering furnace, and
wherein the blow nozzles of the second convection blow means of the tempering furnace form a second plurality of separately-adjustable blow zones in the longitudinal and lateral directions of the tempering furnace, in which a heating effect on the glass sheet of the jets discharged from the blow nozzles is adjustable by adjusting a feeding of an air stream to the blow nozzles, there being at least 40 pieces of the second plurality of separately-adjustable blow zones in the tempering furnace.

2. The tempering furnace as claimed in claim 1, in wherein the first plurality of separately-adjustable blow zones are with a separation of less than 1500 mm in a direction of movement of the glass sheet, and with a separation of at most 300 mm in a direction transverse to the direction of movement of the glass sheet, and the second plurality of separately-adjustable blow zones are with a separation of at most 500 mm in the direction of movement of the glass sheet, and with a separation of at most 250 mm in the direction transverse to the direction of movement of the glass sheet.

3. The tempering furnace as claimed in claim 1, wherein the first plurality of separately-adjustable blow zones are with a separation of less than 1100 mm in a direction of movement of the glass sheet, and with a separation of at most 160 mm in a direction transverse to the direction of movement of the glass sheet, and the second plurality of separately-adjustable blow zones are with a separation of at most 300 mm in the direction of movement of the glass sheet, and with a separation of at most 140 mm in the direction transverse to the direction of movement of the glass sheet.

4. The tempering furnace as claimed in claim 1, where there are at least 6 pieces of the first plurality of separately-adjustable blow zones in the lateral direction of the tempering furnace in the same lateral area, and at least 8 pieces of the second plurality of separately-adjustable blow zones in the lateral direction of the tempering furnace at the same gap between rollers, and at least 16 pieces at two successive gaps between rollers.

5. The tempering furnace as claimed in claim 1, wherein there are at least 6 pieces of the first plurality of separately-adjustable blow zones in the longitudinal direction of the tempering furnace in the same longitudinal area, and at least 12 pieces of the second plurality of separately-adjustable blow zones in the longitudinal direction of the tempering furnace in the substantially same longitudinal line.

6. The tempering furnace as claimed in claim 1, wherein there are at least 80 pieces (N1) of the first plurality of separately-adjustable blow zones in the tempering furnace, and at least 160 pieces of the second plurality of separately-adjustable blow zones in the tempering furnace.

7. The tempering furnace as claimed in claim 1, further comprising third convection blow means in the tempering furnace above the glass sheet, configured to lead pressurized air external to the tempering furnace to blow nozzles of the third blow means, which form a third plurality of separately-adjustable blow zones in the longitudinal and lateral directions of the tempering furnace, in which a heat effect of the air jets discharged from the blow nozzles of the third blow means onto the glass sheet is adjustable by adjusting a feeding of an air stream to the blow nozzles of the third blow means, and the tempering furnace having at least 40 pieces of the third plurality of separately-adjustable blow zones.

8. The tempering furnace as claimed in claim 7, wherein air is fed to the blow nozzles of the third blow means by feed pipes which run through a ceiling of the tempering furnace and which are adapted to run in gaps between the blow enclosures so that the blow nozzles of the third blow means are in the gaps between the blow enclosures or closer to the glass sheet than the blow openings of the first convection blow means.

9. The tempering furnace as claimed in claim 1, wherein one of the first plurality of separately-adjustable blow zones covers a heating surface area of at most 1500 cm2 of the tempering furnace, and one of the second plurality of separately-adjustable blow zones covers a heating surface area of at most 600 cm2 of the tempering furnace.

10. The tempering furnace as claimed in claim 1, wherein feed pipes of the second convection blow means are adapted to run into the tempering furnace through a bottom of the tempering furnace and between gaps of electric elements at a bottom of the tempering furnace so that the blow nozzles blow air towards a bottom surface of the glass sheet from gaps between rollers with a vertical blow distance of no more than 150 mm.

11. The tempering furnace as claimed in claim 1, wherein blow parts of the blow enclosures are installed at an acute angle in relation to the direction of movement of the glass sheet, the angle being from 2 to 10 degrees.

12. The tempering furnace as claimed in claim 1, wherein a shape of the blow nozzles is such that the jet discharged from the blow nozzles is wider in the lateral direction of the tempering furnace than in the direction of movement of the glass sheet within the furnace.

13. The tempering furnace as claimed in claim 1, wherein one blow nozzle of the second convection blow means covers at most 3 separate flow openings, whose focusing centre points on a bottom surface of the glass sheet are at different locations by at least 5 mm and at most 60 in the lateral direction of the furnace.

14. The tempering furnace as claimed in claim 1, wherein the blow nozzles of the second convection blow means blow from successive gaps between rollers in the lateral direction of the furnace onto locations differing by at least 10 mm on the bottom surface of the glass sheet.

15. The tempering furnace as claimed in claim 1, wherein the blow openings of one separately adjustable blow zone of the second convection blow means consists of 2 blow nozzles, at most.

16. A method for heating a glass sheet for tempering, in which method the glass sheet runs on a roller track in a tempering furnace, the method comprising:
heating the glass sheet from top and bottom sides of the glass sheet, including heating a top surface of the glass sheet by hot air jets from first convection blow means, which are formed by sucking air from inside the tempering furnace and pressurizing said hot air, heating the sucked air with electric elements inside blow enclosures, blowing the heated air as jets towards the top surface of the glass sheet, and blowing pressurized air taken from outside the tempering furnace onto a bottom surface of the glass sheet by second convection blow means;
adjusting a heating effect on the top surface of the glass sheet by the air jets discharging from the blow enclosures of the first convection blow means towards the glass sheet by adjusting a feeding of electric current to the electric elements; and
adjusting a heating effect on the bottom surface of the glass sheet by air jets discharged from blow nozzles of the second convection blow means of the tempering furnace by adjusting a feeding of an air stream to the blow nozzles,
wherein the heating effects are adjusted weaker at front and rear ends, and/or side edges, of the glass sheet moving in the tempering furnace than in a centre area of the glass sheet.

17. The method as claimed in claim 16, wherein a blow pressure from the blow nozzles of the second convection blow means, acting on the centre area of the glass sheet, significantly rises during a heating period, at least doubling compared to the blow pressure at an early stage of heating, and the blow pressure of the first convection blow means is at its highest at the early stage of heating.

18. The method as claimed in claim 16, comprising:
blowing pressurized air taken from outside of the tempering furnace onto the top surface of the glass sheet by third convection blow means; and
adjusting the heating effect of the air jets discharging from blow nozzles of the third convection blow means onto the top surface of the glass sheet adjusting a feeding of an air stream to the blow nozzles, and the heating effect of the air jets discharging from blow nozzles of the third convection blow means is adjusted weaker at the front and rear end, and/or side edges, of the glass sheet moving in the tempering furnace than in the centre area of the glass sheet.
